(19) United States
(12) Patent Application Publication
(10) Pub. No.: US 2026/0133069 A1
(43) Pub. Date: May 14, 2026

(54) SYSTEM AND METHOD FOR SMARTPHONE-BASED SPECTROMETRY FOR ASSESSING HEALTH AND NUTRITION STATUS

(71) Applicant: University of Virginia Patent Foundation, Charlottesville, VA (US)

(72) Inventors: Afsaneh Doryab, Charlottesville, VA (US); Andrew James Balch, Yorktown, VA (US)

(21) Appl. No.: 19/390,069

(22) Filed: Nov. 14, 2025

Related U.S. Application Data
(60) Provisional application No. 63/720,405, filed on Nov. 14, 2024.

(51) Int. Cl. G01J 3/02; H04M 1/02; H04N 23/56; H04N 23/57

(52) U.S. Cl. CPC G01J 3/0291; G01J 3/024; G01J 3/0272; H04M 1/0264; H04N 23/56; H04N 23/57

(57) ABSTRACT

A smartphone-based spectrophotometer in various embodiments, comprises: a housing comprising a front face, a rear face, a reflective surface, and a diffraction grating disposed in the interior of the housing; a cuvette holder configured to receive a cuvette holding a sample and couple the cuvette adjacent the front face; and a light source. In some embodiments, the front face defines a slit disposed adjacent the sample when the cuvette holder is coupled to the housing; the housing is configured to support a smartphone having a camera adjacent the rear face of the housing, with the camera facing the housing; the light source is configured to cause light to pass through the sample, through the slit, reflect off the mirror, diffract off the diffraction grating and into the camera to capture an image. In some embodiments, the image is analyzed to identify a nutrient content of the sample.

### CROSS-REFERENCE TO RELATED APPLICATION

This application claims the benefit of U.S. Provisional Patent Application Ser. No. 63/720,405, filed Nov. 14, 2024, the disclosure of which is hereby incorporated herein by reference in its entirety.

### BACKGROUND

Micronutrient imbalance is a global issue, and its detection is invasive and expensive. Despite being largely preventable, imbalances of one or more micronutrients is pervasive and has major downstream health effects. Women, children, and underserved populations in particular bear the greatest burden of micronutrient imbalance. However, the true scope of this issue is often unseen and unaddressed because of the barriers to accessible micronutrient status assessment. Status assessment of micronutrients is often done via indirect, subjective dietary logs, in-person clinical examinations, or complex analyses on blood (e.g. liquid chromatography-coupled mass spectrometry). While valuable, these assessments are expensive, flawed, and burdensome on the patient and the clinician.

### SUMMARY

In general, various aspects of the present invention provide methods, apparatuses, systems, computing devices, computing entities, and/or the like for providing a spectrophotometer; capturing, using the spectrophotometer, an image of a sample; extracting, using computing hardware, an intensity profile from the image; processing, using computing hardware, the intensity profile based on one or more image capture conditions; and applying, by the computing hardware, a calibration factor to the processed intensity profile to determine an amount of a nutrient in the sample. In some embodiments, the spectrophotometer comprises a smartphone having a camera, a light source, and a housing; the housing defines a slit configured to receive light from the light source; and the housing comprises a first reflective surface configured to redirect light from the light source to a polycarbonate substrate configured to refract the light into a camera sensor of the camera. In various embodiments, the slit is formed by a first and second razor blade disposed on the housing. In some embodiments, the polycarbonate substrate comprises an optical disc.

In particular embodiments, processing the intensity profile based on the one or more image capture conditions comprises: determining the one or more image capture conditions includes at least one of a set of lighting conditions, a background color, a container type in which the sample is disposed, or a source of the sample; and modifying the intensity profile based on the one or more image capture conditions by applying a modifier defined by the one or more image capture conditions. In various aspects, applying the calibration factor comprises subtracting at least one reference spectra from the processed intensity profile. In some aspects, subtracting the at least one reference spectra comprises subtracting at least one of a reference spectra for at least one other nutrient or a reference spectra for a solvent in which the sample is dissolved.

A smartphone-based spectrophotometer, in various embodiments comprises: a housing comprising a front face, a rear face, a reflective surface support portion disposed between the front face and the rear face at an angle adjacent a base of the housing, and a diffraction grating support portion extending from an upper portion of the front face to a portion of the housing adjacent an upper portion of the rear face; a reflective surface disposed on the reflective surface support portion in an interior of the housing; a diffraction grating disposed on the diffraction grating support portion in the interior of the housing; a cuvette holder configured to receive a cuvette having a sample therein and at least temporarily couple the cuvette adjacent the front face; and a light source. In some embodiments, the front face defines a slit disposed adjacent the sample when the cuvette holder is coupled to the housing; the housing is configured to support a smartphone having a camera adjacent the rear face of the housing, with the camera facing the housing; the light source is configured to cause light to pass through the sample, through the slit, reflect off the mirror and into the diffraction grating; and the diffraction grating is configured to direct incident light from the diffraction grating into the camera.

In various embodiments, the angle is forty five degrees. In some embodiments, the housing comprises a first razor blade and a second razor blade disposed adjacent the slit and spaced apart from one another; and the first razor blade and the second razor blade define the slit. In some aspects, a first sharpened edge of the first razor blade is parallel to and spaced apart a distance from a second sharpened edge of the second razor blade. In some embodiments, the distance is up to about 3 millimeters. In some embodiments, the diffraction grating comprises an optical disk.

A method of determining an amount of a nutrient in a sample, according to various aspects, comprises: providing a spectrophotometer; capturing, using the spectrophotometer, an image of the sample; generating, by computing hardware, a pixel intensity profile of the image; mapping, by the computing hardware, a pixel position of each pixel to a wavelength; calculating, by the computing hardware, an absorbance at least wavelength; generating, by the computing hardware, an absorbance spectra based on the absorbance at each wavelength; and providing, by the computing hardware, the absorbance spectra for display on a computing device.

In some embodiments, the spectrophotometer is a smartphone-based spectrophotometer comprising: a housing comprising a front face, a rear face, a reflective surface support portion disposed between the front face and the rear face at an angle adjacent a base of the housing, and a diffraction grating support portion extending from an upper portion of the front face to a portion of the housing adjacent an upper portion of the rear face; a reflective surface disposed on the reflective surface support portion in an interior of the housing; a diffraction grating disposed on the diffraction grating support portion in the interior of the housing; a cuvette holder configured to receive a cuvette having a sample therein and at least temporarily couple the cuvette adjacent the front face; and a light source. In particular embodiments, the front face defines a slit disposed adjacent the sample when the cuvette holder is coupled to the housing; the housing is configured to support a smartphone having a camera adjacent the rear face of the housing, with the camera facing the housing; the light source is configured to cause light to pass through the sample, through the slit, reflect off the mirror and into the diffraction grating; and the diffraction grating is configured to direct incident light from the diffraction grating into the camera to capture the image.

In particular embodiments, the method comprises determining, based on the absorbance spectra, an amount of the nutrient in the sample. In other embodiments, the method comprises modifying the absorbance spectra based on one or mor reference spectra. In some embodiments, modifying the absorbance spectra comprises subtracting at least one of the one or more reference spectra from the absorbance spectra. In particular embodiments, subtracting the at least one of the one or more reference spectra comprises subtracting at least one of a reference spectra for at least one other nutrient or a reference spectra for a solvent in which the sample is dissolved.

### BRIEF DESCRIPTION OF THE DRAWINGS

In the course of this description, reference will be made to the accompanying drawings, which are not necessarily drawn to scale, and wherein:

FIG. 1 depicts an example of a computing environment that can be used for capturing and analyzing imaging data to identify nutrient content of a sample according to various aspects of the present disclosure;

FIG. 2 depicts an example of a process for capturing imaging data for use in analyzing samples to identify nutrient content in accordance with various aspects of the present disclosure;

FIG. 3 depicts an example of a housing for use in performing spectrophotometry using a mobile computing device such as a smart phone in accordance with various embodiments of the present disclosure;

FIG. 4 depicts an exemplary cuvette holder in accordance with various aspects of the resent disclosure;

FIG. 5 depicts an example of a configuration for capturing an image of a sample for use in identifying nutrient content of the sample in accordance with various aspects of the present disclosure;

FIG. 6 depicts an example of a process for analyzing imaging data for identifying nutrient content of sample in accordance with various aspects of the present disclosure;

FIG. 7 depicts an example of a system architecture that may be used in accordance with various aspects of the present disclosure; and

FIG. 8 depicts an example of a computing entity that may be used in accordance with various aspects of the present disclosure.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the disclosure. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method and/or process can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an,” and “the” include plural referents unless the context clearly dictates otherwise. Thus, for example, reference to “a spacer,” “a guide nucleic acid,” or “an miRNA,” including, but not limited to, mixtures or combinations of two or more such spacers, guide nucleic acids, or miRNAs, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### Overview

Balanced nutrition is crucial for the growth and proper functioning of the human body. The World Health Organization (WHO) reports that individuals with proper nutrition have increased lifespans, are more likely to break cycles of poverty, and have lower risks of disease, which impacts mortality. Nutrient imbalance, an excess or a deficiency of nutrients, is a global health issue with major downstream health effects. Women, children, and underserved populations, in particular, bear the greatest burden of nutrient imbalance. Anemia is an example of a major resulting disease; it affects 37% of pregnant people and 40% of children under five years of age. Moreover, nutrient deficiency is linked to a staggering 45% of deaths in children under five years old, highlighting the severity of the nutrient imbalance, which is often challenging to identify and, consequently, hard to prevent.

Methods for measuring nutrient levels present several limitations, further perpetuating the imbalance issue. A nutrient assessment often requires invasive, expensive, and in-person clinic visits, making awareness of nutritional status largely inaccessible. Current methods are done via indirect, subjective dietary logs, in-person clinical examinations, and complex in-lab analyses on blood (e.g., liquid chromatography-coupled mass spectrometry). While valuable, these assessments are expensive, flawed, and burdensome for the patient and the clinician.

Various techniques for nutrient status detection described herein, using low-cost, convenient components, such as a smartphone, may provide more accessible nutrient detection, especially in resource-constrained environments. As a step in this direction, various embodiments described herein utilize smartphone-based spectrophotometry. Spectrophotometry is the analysis of light (primarily visible light) as it is absorbed and transmitted by a compound it passes through. The relative concentration and identity of a compound, in various aspects described herein, can be determined by analyzing its absorbance at specific wavelengths.

Various embodiments described herein provide methods and systems for identifying biochemicals (e.g., nutrients) using only one or more images without any physical device or physical reading of a sample.

### Example Computing Environment

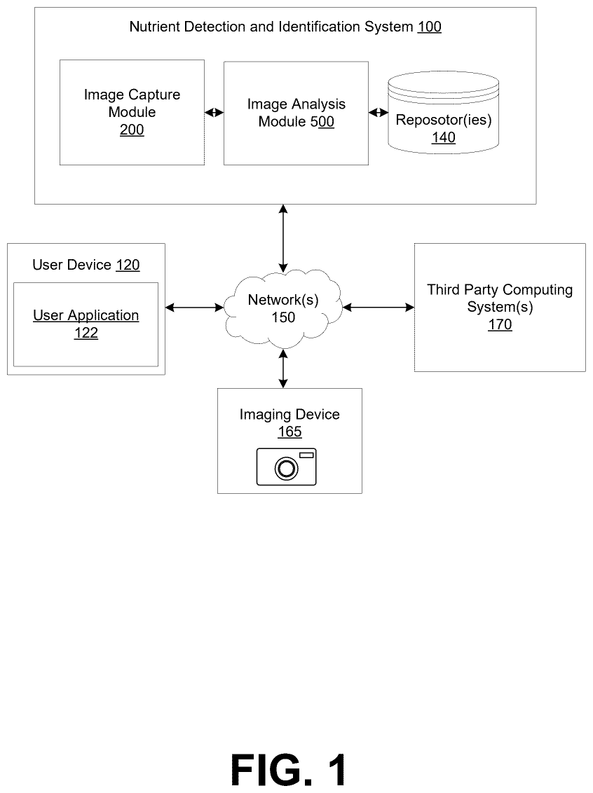

FIG. 1 depicts an example of a computing environment that can be used for capturing and analyzing imaging data to identify nutrient content of a sample according to various aspects of the present disclosure. For example, users may use a computing system to capture one or more images of a sample. The computing environment may then be used to analyze the image to identify nutrient content and other data about the sample simply from the image (e.g., without physical access to the sample or other equipment).

In various aspects, a nutrient detection and identification system 100 is provided within the computing environment that includes software components and/or hardware components to aid users in capturing images of a sample for use in analyzing the sample, performing the actual analysis, and the like. For instance, the nutrient detection and identification system 100 may provide access to a nutrient detection and identification platform that is accessible over one or more networks 150 (e.g., the Internet) by a user accessing a user application 122 on a user computing device 120. In some embodiments, the user device may include an imaging device 165 (e.g., a camera having at least one camera sensor). In some embodiments, the system is configured to enable a user of a mobile computing device 120 (e.g., smartphone) to use a suitable housing on the user device 120 to capture suitable imagery for use in the nutrient analysis described herein.

Here, the nutrient detection and identification system 100 may provide the user computing device 120 with one or more graphical user interfaces (e.g., webpages, software applications, etc.) through the service to access the nutrient detection and identification system 100. The user may use the service in performing functionality associated with image capture and analysis.

In addition to the graphical user interfaces, the nutrient detection and identification system 100 may include one or more interfaces (e.g., application programming interfaces (APIs)) for communicating and/or accessing third party computing system(s) 170 over the network(s) 150. For instance, the nutrient detection and identification system 100 may access a third party computing system 170 via one of the interfaces to access imaging device configuration data and calibration data, access known nutrient absorption graphs, perform computing steps described herein, and the like.

In some instances, the nutrient detection and identification system 100 may include one or more repositories 140 that can be used for storing data related to calibration settings, offsetting graph data, and the like. In other aspects, the one or more repositories 140 may store data related to known absorbance graphs for comparison purposes and other suitable purposes.

In some aspects, the nutrient detection and identification system 100 executes an image capture module 200 for capturing imaging data for use in analyzing samples to identify nutrient content. In some aspects, the image capture module 200 may provide for controlled capture (e.g., in terms of angle, distance, illumination, background, reference objects, settings, and the like) to provide greater accuracy in performing nutrient identification during downstream analysis. In some aspects, the image capture process may include set up steps performed by an entity other than a computing entity.

In some other aspects, the nutrient detection and identification system 100 executes an image analysis module 600 for analyzing imaging data for identifying nutrient content of a sample. In various aspects, the nutrient detection and identification system 100 is configured to analyze an image of a sample (e.g., blood, saliva, skin, etc.) to determine the content of at least one nutrient in the sample (e.g., a particular vitamin content, etc.).

Further detail is provided below regarding the configuration and functionality of the image capture module 200, and image analysis module 600, according to various aspects of the disclosure.

It should be understood that various aspects of this disclosure refer to determining nutrient content of samples and the like. In various aspects, any such reference should be understood to encompass any suitable content of any suitable object, item, fluid, or other sample.

The number of devices depicted in FIG. 1 are provided for illustrative purposes. In some aspects, different number of devices may be used. In various aspects, for example, while certain devices or systems are shown as single devices in FIG. 1, multiple devices may instead be used to implement these devices or systems.

In some aspects, the nutrient detection and identification system 100 can include one or more third-party devices such as, for example, one or more servers operating in a distributed manner. The nutrient detection and identification system 100 can include any computing device or group of computing devices, and/or one or more server devices.

Although the data repository 140 is shown as a single component, these components 140 may include, in other aspects, a single server and/or repository, servers and/or repositories, one or more cloud-based servers and/or repositories, or any other suitable configuration.

### Image Capture Module and Process

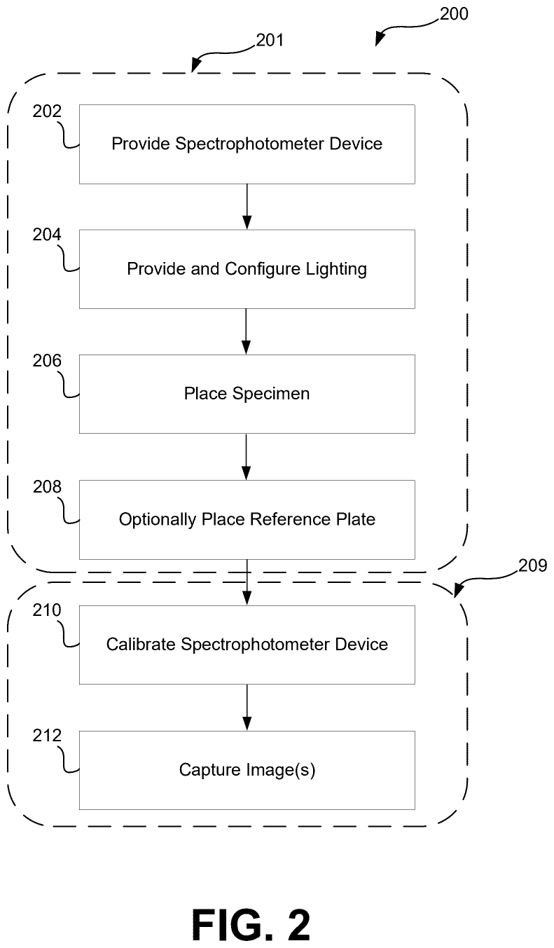

Turning now to FIG. 2, additional details are provided regarding an image capture module 200 for capturing one or more images and other imaging data for analyzing samples to identify nutrient content. For instance, the flow diagram shown in FIG. 2 may correspond to operations executed by computing hardware found in the nutrient detection and identification system 100 as it executes the image capture module 200. In other embodiments, the image capture process 200 includes method steps performed in the set up and calibration of an imaging device 165 to provide suitable imagery for downstream analysis and nutrient identification.

The image analysis process includes a set of process steps 201 that include a set up of a scene that is suitable, in some embodiments, for using the imaging device 165 to capture one or more suitable images. At step 202, the process involves providing a spectrophotometer device. In some embodiments, the spectrophotometer device includes a mobile computing device 120 (e.g., a smart phone) and a housing configured to receive the smart phone.

Spectrophotometers can be cost-prohibitive. To make spectrophotometry more accessible, smartphones are increasingly utilized in designs, with researchers taking advantage of their high-resolution camera, light-emitting-diode (LED) flash, and processing power. However, existing designs are still complex, costly, and require inaccessible components. Although there are DIY smartphone based spectrophotometer designs for educational purposes they are generally concerned with making simple, cost-effective devices that can be replicated by students. As a result, many do not verify their devices'accuracy with benchtop laboratory-grade spectrophotometers, limiting their potential use in applications that require high precision. Additionally, most smartphone-based spectrophotometer applications are used in conjunction with calorimetry, which requires a carefully prepared chemical reaction involving particular reagents to quantify and detect the compound of interest.

Various embodiments described herein provide advances in the utility of accessible, smartphone-based spectrophotometry for nutrition assessment. Various embodiments described herein explore the potential of smartphone based spectrophotometry to detect and quantify nutrients directly in solution, an application that has been ignored in favor of more complex colorimetric methods. This may be a critical step towards the most accessible manner of assessing nutrients within the human body.

Various embodiments of a smartphone-based spectrophotometry device are described herein. Various embodiments of a smartphone-based spectrophotometry device comprise light source, which emits light through a sample and into a light slit. The incoming light may then be separated into individual wavelengths by a suitable diffraction grating and imaged with the smartphone camera. In some embodiments, the device comprises at-home materials and is inserted into a blacked-out box to reduce and/or minimize outside light. In some embodiments, the slit comprises two adjacent razor blades with their sharp, parallel edges fastened a few millimeters apart and defining a narrow slit (e.g., defined by the distance between the two adjacent razor blades). In some embodiments, the diffraction grating comprises an optical disk, such as a DVD, CD-ROM, and the like. In other embodiments, the diffraction grating includes any suitable polycarbonate substrate. In some embodiments, the assembly is inserted into one end of the box, opposite of a light source. A sample in a clear plastic container may then be placed in the middle, in the path of light. When a smartphone is laid against the diffraction grating on the outside of the light-proof container, it can capture an image of the light spectrum transmitted through the sample.

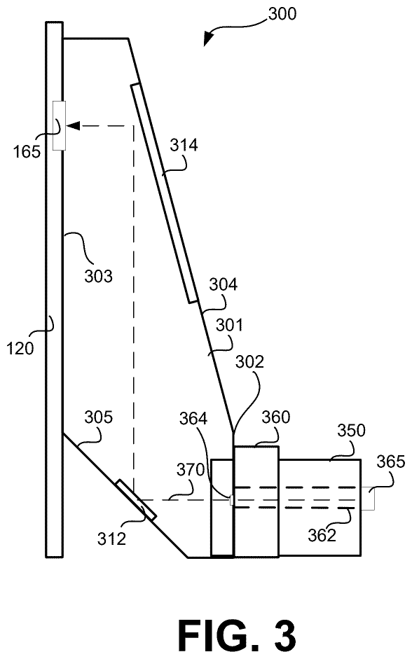

In still other embodiments, the smartphone-based spectrophotometer device comprises a 3D-printed, periscope-like housing assembly (e.g., as shown in FIG. 3) Again, two razor blades are used to create a narrow, straight slit for light to pass through. Internally, the light from the slit bounces off a mirror and into the diffraction grating. The incident (reflected) light from the diffraction grating is directed into the smartphone camera sensor. The housing is attached directly onto a smartphone case such that the smartphone's camera is positioned in the center of the spectrometer's opening. This integration provides several advantages: (1) it is more compact and portable, and (2) it eliminates errors arising from the need to reposition the smartphone.

In additional embodiments, a cuvette holder is used in combination with the main assembly that attached directly to the main assembly. To accommodate larger, more intense light sources (e.g. a LED bulb) and allow light to easily pass through, various embodiments include two relatively large, square openings integrated on either side of the cuvette. In various embodiments, one faces the light source and the other faces into the device. Additional detail regarding embodiment of the smartphone-based spectrophotometer device and cuvette holder are discussed below.

Turning to FIG. 3, an exemplary smartphone-based spectrophotometer 300 in accordance with particular embodiments is shown. As may be understood form this figure, the smartphone-based spectrophotometer 300, in some embodiments, comprises a housing 301 having a front face 302 and a back face 303 that is substantially parallel to and spaced apart from the front face 302. The smartphone-based spectrophotometer 300 further comprises a reflective surface support portion 305 that extends from adjacent the front face 302 to the rear face 303. In various embodiments, the reflective surface support portion 305 forms a substantially 45 degree angle with the front face 302 and rear face 303. In some embodiments, a reflective surface 312 (e.g., mirror) is disposed on the reflective surface support portion 305. In particular embodiments, the housing 301 further comprises a diffraction grating support portion 304 that extends from the front face 302 to adjacent an upper portion of the rear face 303. In some embodiments, the diffraction grating support portion 304 comprises a diffraction grating 314 disposed on an interior portion of the housing 301. In some embodiments, the diffraction grating comprises an optical disk.

In particular embodiments, smartphone-based spectrophotometer 300 is configured to receive and maintain a smartphone (e.g., computing device 120) adjacent the rear ace 303 such that an imaging device 165 of the smartphone 120 is positioned to receive diffracted light from the diffraction grating 314. In some embodiments, the smartphone-based spectrophotometer 300 further comprises a cuvette holder 360, light assembly 350, and a light source 365. In some embodiments, the light assembly 350 and cuvette holder 360 define a light path 362 from the light source 365 to a slit 364 defined in the front face 302 of the housing 301.

As may be understood from FIG. 3, the light source 365 is configured to cause light to pass through a sample disposed in the cuvette holder 360, through the slit, 364, reflect off of the reflective surface 312, diffract off of the diffraction grating 314, and impinge upon the imaging device 165. Because of the configuration of the smartphone-based spectrophotometer 300, the smartphone-based spectrophotometer 300 is configured to provide reproducible, repeatable imaging conditions for imaging a sample in the cuvette holder 360.

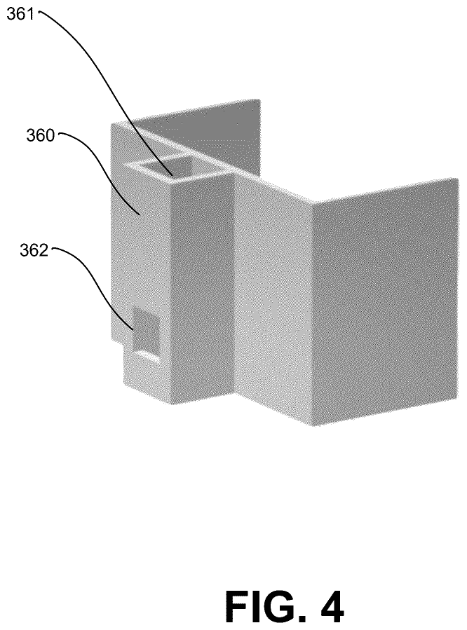

FIG. 4. Depicts a cuvette holder 360 according to particular embodiments, as shown in this figure, the cuvette holder 360 defines the light path 362 via an opening and includes a cuvette receiving cavity 361 for receiving a cuvette containing a sample. As shown in this figure, the cuvette holder 360 comprises a first housing engaging portion 368 and a second housing engaging portion 369 configured to engage the housing 301 adjacent the front face such that the cuvette receiving cavity is disposed adjacent the front face 302. In this way, the first housing engaging portion 368 and a second housing engaging portion 369 are configured to cooperate to hold the cuvette with a sample therein in front of the slit 364 to enable the image capture technique described herein. Through use of a reproduceable, consistent housing 301 and cuvette holding structure 360, the smartphone-based spectrophotometer 300 enables consistent, comparable, reproducible spectral imagery of samples to provide consistent, repeatable nutrient identification through imagery.

Returning to FIG. 2, At Step 204, the process includes providing and configuring lighting. In some embodiments, configuring lighting include placing a light source in a particular location (e.g., relative to a sample). For example, FIG. 3 (as discussed above) depicts a light source 365 disposed in a particular location relative to a sample in a cuvette holder 360 and other accompanying structure of a smartphone-based spectrophotometer 300. In particular embodiments, configuring the light source comprises selecting a particular light type. For example, in some embodiments, configuring lighting includes selecting a light with a particular color temperature (e.g., 2800K, 3500K, 4000K, or any other suitable color temperature). In some embodiments, configuring the lighting includes selecting a light bulb of a particular type (e.g., LED, CFL, Incandescent, and the like). Appendix A (which is incorporated herein in its entirety) includes various examples of lighting configurations and potential lighting selections in accordance with particular embodiments of the present disclosure.

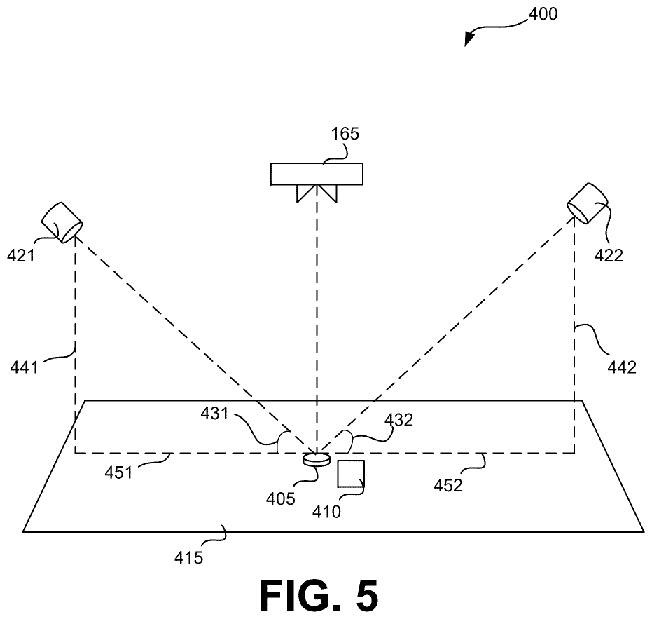

FIG. 5 depicts an exemplary lighting scene 400 having an imaging device 165 (e.g., a Specim IQ) and a first and second light source 421, 422, each a respective distance 441, 442 from a support surface 415. In some embodiments, the first and second light source 421, 422 are each a respective distance 451, 452 laterally from the sample 405, and form an angle 431, 432 with respect to the sample 405 and support surface 415. A sample 405 is placed on a support surface below the imaging device 165. In some embodiments, the support surface 415 comprises a backdrop (e.g., carboard, table) of a particular color. In other embodiments, a reference plate 410 is positioned adjacent the sample 405 and has a particular color (e.g., white, black, etc.).

At Step 206, the process includes placing the specimen. In some embodiments, placing the specimen comprises placing the specimen in a particular container (e.g., a vial, a beaker, petri dish, etc.). In other embodiments, placing the specimen comprises placing the specimen in a cuvette (e.g., for use with a smartphone-based spectrophotometer). Specimen placemen in various embodiments is discussed throughout this disclosure. In some embodiments, the system is configured to rely on consistent, repeatable specimen placement that depends on a type of imaging device utilized.

At Step 208, the process may involve placing a reference plate. In some embodiments, the process involves placing a reference plate adjacent the sample. In particular embodiments, the reference plate may provide one or more known spectra for configuration purposes when imaging the sample.

The image capture process 200 further includes one or more computer-implemented operations 209. In some embodiments, at operation 210, the process involves calibrating the spectrophotometer device. This may include, for example, setting one or more image capture settings (e.g., frequency, resolution, etc.).

At operation 212, the system captures one or more images. In some embodiments, the one or more images comprise one or more images of light that has passed through a sample for which nutrient content distillation is desired.

For illustrative purposes, the image capture process 200 is described with reference to implementations described above with respect to one or more examples described herein. Other implementations, however, are possible. In some aspects, the steps in FIG. 2 may be implemented in program code that is executed by one or more computing devices such as the nutrient detection and identification system 100, the user device 120, or other system in FIG. 1. In some aspects, one or more operations shown in FIG. 2 may be omitted or performed in an order other than shown. In some aspects, one or more steps may be performed by an entity other than a computing entity (i.e., an individual setting up a sample, positioning a light, or otherwise configuring or producing one of the listed steps or other steps.

### Image Analysis Module and Process

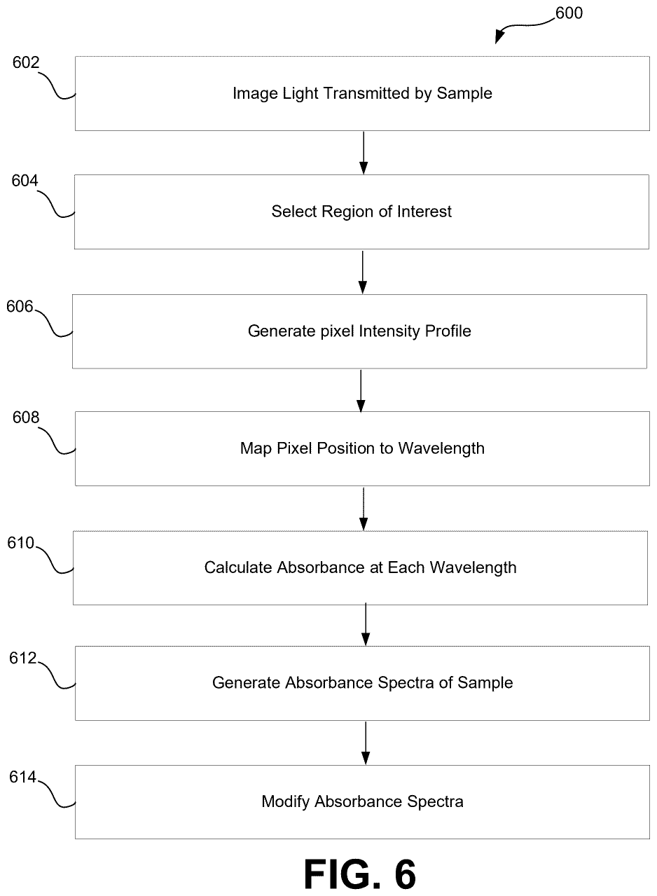

Turning now to FIG. 6, additional details are provided regarding an image analysis module 600 for analyzing imaging data for identifying nutrient content of sample. For instance, the flow diagram shown in FIG. 6 may correspond to operations executed by computing hardware found in the nutrient detection and identification system 100 as it executes the image analysis module 600. Appendices A and B (which are incorporated herein in their entirety)provide additional detail with regard to the process for analyzing imagery to derive nutrient content of a sample.

At operation 602, the system images light transmitted by a sample. In various embodiments, the system may use the imaging device 165 and any other equipment, housing, etc. described herein to capture one or more images of a sample.

At operation 604, the system selects a region of interest from the image. In some embodiments, the process involves extracting a transmittance spectra from the one or more images. In other embodiments, the region of indicates the portion of the imagery in which the sample is disposed.

At operation 606, the system generates a pixel intensity profile for the image. The pixel intensity profile may represent an amount of photons (light intensity) absorbed and transmitted after light passes through the sample. In some embodiments, interaction of a compound with electromagnetic radiation can reveal its intrinsic properties and allow for identification and quantification.

At operation 608, the process involves mapping pixel position to wavelength. This may involve, for example, mapping the location of each peak in horizontal pixels of the image to the wavelength at which it is known to appear (e.g., based on one or more reference spectra). In some embodiments, the system utilizes a linear regression mode from labelled calibration data to derive the pixel position at each wavelength.

At operation 610, the system calculates absorbance at each wavelength. In some embodiments, the system uses reference data from a blank sample to calculate the absorbance. At operation 612, the system generates an absorbance spectra of the sample.

At operation 614, the system may modify the absorbance spectra. This may involve, for example, subtracting one or more reference spectra from the absorbance spectra. In some embodiments, this may involve subtracting at least one reference spectra for at least one nutrient other than a nutrient for which the process is being implemented for identification purposes. In other embodiments, this may involve subtracting at least one reference spectra for a solvent in which the sample is dissolved. In this way, the system is configured to eliminate absorbance spectra of components of a sample that are not of interest, to provide identifying information about a specific nutrient of interest. (e.g., vitamin B, vitamin D, and the like).

In some embodiments, the process described herein can provide sufficiently accurate nutrient quantification in samples when compared to a laboratory spectrophotometer. In various embodiments, particular nutrients at particular concentrations may have a substantially distinct spectra to identify the nutrient type and quantity from the spectra (i.e., because the spectra is sufficiently distinct form other spectra to enable unique identification of at least the nutrient type and/or a quantity of the nutrient in the sample). In particular embodiments, analysis is performed using Beer-Lambert's Law, related to the relationship between attenuation in intensity of a radiation beam passing through a macroscopically homogeneous medium with which it interacts. In some embodiments, the intensity of radiation decays exponentially in the absorbance of the medium, and the absorbance is proportional to the length of the beam passing through the medium, the concentration of interacting matter along that path, and a constant representing the matter's propensity to interact. As such, a beam of visible light passing through a chemical solution (e.g., a solution containing an unknown nutrient concentration) of fixed geometry experiences absorption proportional to the solute concentration. As such, using Beer's law in the analysis, the concentration of the solute (e.g., nutrient) in a solution can be determined. In particular, the mechanisms described herein enable smartphone-based spectrophotometry in place of spectrophotometry in lab conditions (e.g., with accuracy at or approaching laboratory conditions).

### Example Technical Platforms

Aspects of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example aspects, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). A machine-readable storage medium or computer-readable storage medium may include a non-transitory medium in which data can be stored and that does not include carrier waves or transitory electronic signals.

In some aspects, a non-volatile computer-readable storage medium may include a floppy disk, flexible disk, hard disk, solid-state storage (SSS) (e.g., a solid-state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some aspects, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where various aspects are described to use a computer-readable storage medium, other types of computer-readable storage media may be substituted for or used in addition to the computer-readable storage media described above.

Various aspects of the present disclosure may also be implemented as methods, apparatuses, systems, computing devices, computing entities, and/or the like. As such, various aspects of the present disclosure may take the form of a data structure, apparatus, system, computing device, computing entity, and/or the like executing instructions stored on a computer-readable storage medium to perform certain steps or operations. Thus, various aspects of the present disclosure also may take the form of entirely hardware, entirely computer program product, and/or a combination of computer program product and hardware performing certain steps or operations.

Various aspects of the present disclosure are described below with reference to block diagrams and flowchart illustrations. Thus, each block of the block diagrams and flowchart illustrations may be implemented in the form of a computer program product, an entirely hardware aspect, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some examples of aspects, retrieval, loading, and/or execution may be performed in parallel such that multiple instructions are retrieved, loaded, and/or executed together. Thus, such aspects can produce specially configured machines performing the steps or operations specified in the block diagrams and flowchart illustrations. Accordingly, the block diagrams and flowchart illustrations support various combinations of aspects for performing the specified instructions, operations, or steps.

### Example System Architecture

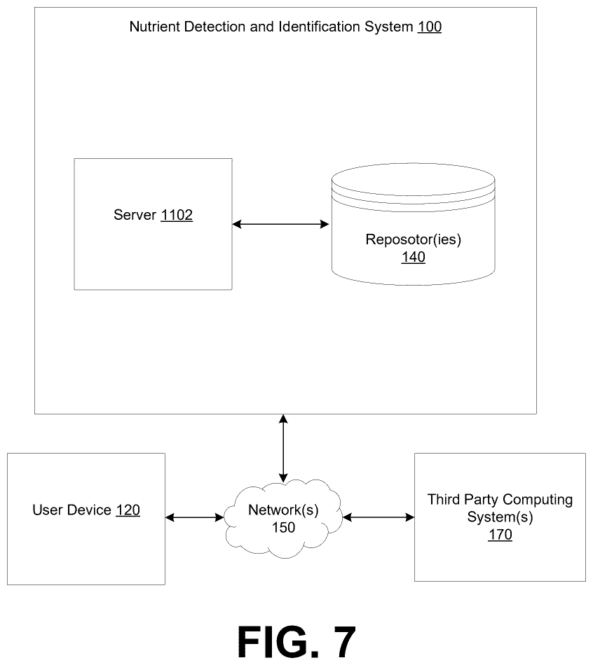

FIG. 7 is a block diagram of an example of a system architecture 1100 that can be for diagnosing and generating treatment plans for particular conditions based on object transfer task analysis as described herein. As may be understood from FIG. 7, the system architecture 1100 in some aspects may include a nutrient detection and identification system 100 that comprises one or more servers 1102 and a data repository 140. The data repository 140 may be made up of computing components such as servers, routers, data storage, networks, and/or the like that are used to store configuration data, reference spectra, and the like.

As previously noted, the nutrient detection and identification system 100 may provide a platform that is available more networks 150. Here, an entity may access the service via a user device 120. For example, the nutrient detection and identification system 100 may provide the service through a website that is accessible to the user device 120 via the one or more networks 150, a software application on the user device 120 and the like.

Accordingly, the server(s) 1102 may execute the image capture module 200 and image analysis module 600 as described herein. Further, according to particular aspects, the server(s) 1102 may provide one or more graphical user interfaces (e.g., one or more webpages, webform, and/or the like through the website) through which users can interact with the object transfer task analysis system 100. Furthermore, the server(s) 1102 may provide one or more interfaces that allow the nutrient detection and identification system 100 to communicate with third-party computing system(s) 170 such as one or more suitable application programming interfaces (APIs), direct connections, and/or the like.

### Example Computing Hardware

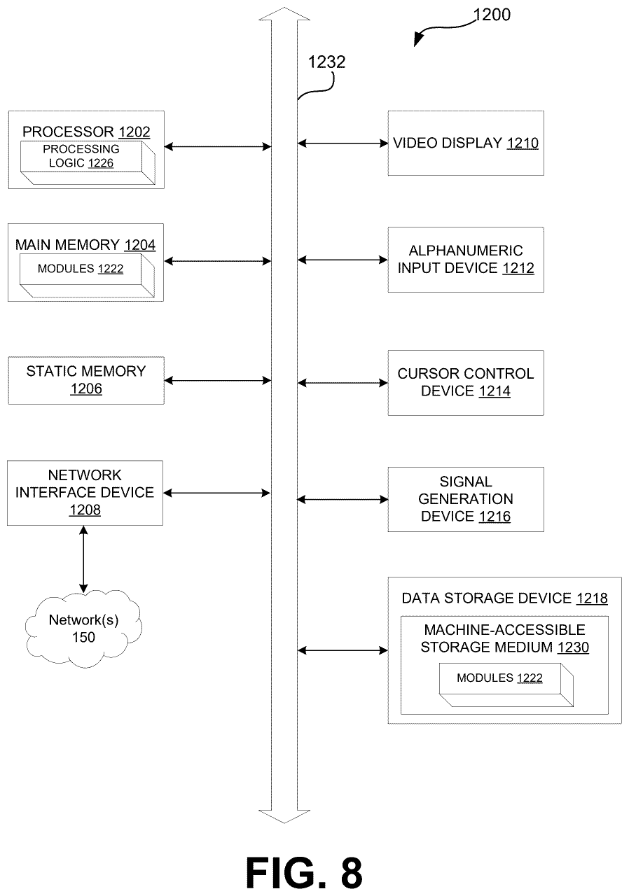

FIG. 8 illustrates a diagrammatic representation of a computing hardware device 1200 that may be used in accordance with various aspects. For example, the hardware device 1200 may be computing hardware such as a server 120 as described in FIG. 7. According to particular aspects, the hardware device 1200 may be connected (e.g., networked) to one or more other computing entities, storage devices, and/or the like via one or more networks such as, for example, a LAN, an intranet, an extranet, and/or the Internet. As noted above, the hardware device 1200 may operate in the capacity of a server and/or a client device in a client-server network environment, or as a peer computing device in a peer-to-peer (or distributed) network environment. In some aspects, the hardware device 1200 may be a personal computer (PC), a tablet PC, a set-top box (STB), a Personal Digital Assistant (PDA), a mobile device (smartphone), a web appliance, a server, a network router, a switch or bridge, or any other device capable of executing a set of instructions (sequential or otherwise) that specify actions to be taken by that device. Further, while only a single hardware device 1200 is illustrated, the term “hardware device,” “computing hardware,” and/or the like shall also be taken to include any collection of computing entities that individually or jointly execute a set (or multiple sets) of instructions to perform any one or more of the methodologies discussed herein.

A hardware device 1200 includes a processor 1202, a main memory 1204 (e.g., read-only memory (ROM), flash memory, dynamic random-access memory (DRAM) such as synchronous DRAM (SDRAM), Rambus DRAM (RDRAM), and/or the like), a static memory 1206 (e.g., flash memory, static random-access memory (SRAM), and/or the like), and a data storage device 1218, that communicate with each other via a bus 1232.

The processor 1202 may represent one or more general-purpose processing devices such as a microprocessor, a central processing unit, and/or the like. According to some aspects, the processor 1202 may be a complex instruction set computing (CISC) microprocessor, reduced instruction set computing (RISC) microprocessor, very long instruction word (VLIW) microprocessor, a processor implementing other instruction sets, processors implementing a combination of instruction sets, and/or the like. According to some aspects, the processor 1202 may be one or more special-purpose processing devices such as an application specific integrated circuit (ASIC), a field programmable gate array (FPGA), a digital signal processor (DSP), network processor, and/or the like. The processor 1202 can execute processing logic 1226 for performing various operations and/or steps described herein.

The hardware device 1200 may further include a network interface device 1208, as well as a video display unit 1210 (e.g., a liquid crystal display (LCD), a cathode ray tube (CRT), and/or the like), an alphanumeric input device 1212 (e.g., a keyboard), a cursor control device 814 (e.g., a mouse, a trackpad), and/or a signal generation device 1216 (e.g., a speaker). The hardware device 1200 may further include a data storage device 1218. The data storage device 1218 may include a non-transitory computer-readable storage medium 1230 (also known as a non-transitory computer-readable storage medium or a non-transitory computer-readable medium) on which is stored one or more modules 1222 (e.g., sets of software instructions) embodying any one or more of the methodologies or functions described herein. For instance, according to particular aspects, the modules 1222 include the image capture module 200 and image analysis module 600 as described herein. The one or more modules 1222 may also reside, completely or at least partially, within main memory 804 and/or within the processor 802 during execution thereof by the hardware device 1200—main memory 1204 and processor 1202 also constituting computer-accessible storage media. The one or more modules 1222 may further be transmitted or received over a network 150 via the network interface device 1208.

While the computer-readable storage medium 1230 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 1200 and that causes the hardware device 1200 to perform any one or more of the methodologies of the present disclosure. The term “computer-readable storage medium” should accordingly be understood to include, but not be limited to, solid-state memories, optical and magnetic media, and/or the like.

### System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These states, operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### Conclusion

While this specification contains many specific aspect details, these should not be construed as limitations on the scope of any invention or of what may be claimed, but rather as descriptions of features that may be specific to particular aspects of particular inventions. Certain features that are described in this specification in the context of separate aspects also may be implemented in combination in a single aspect. Conversely, various features that are described in the context of a single aspect also may be implemented in multiple aspects separately or in any suitable sub-combination. Moreover, although features may be described above as acting in certain combinations and even initially claimed as such, one or more features from a claimed combination may in some cases be excised from the combination, and the claimed combination may be a sub-combination or variation of a sub-combination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various components in the various aspects described above should not be understood as requiring such separation in all aspects, and the described program components (e.g., modules) and systems may be integrated together in a single software product or packaged into multiple software products.

Many modifications and other aspects of the disclosure will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for the purposes of limitation.

What is claimed is:

1. A method comprising:
providing a spectrophotometer;
capturing, using the spectrophotometer, an image of a sample;
extracting, using computing hardware, an intensity profile from the image;
processing, using computing hardware, the intensity profile based on one or more image capture conditions;
applying, by the computing hardware, a calibration factor to the processed intensity profile to determine an amount of a nutrient in the sample.

2. The method of claim 1, wherein:
the spectrophotometer comprises a smartphone having a camera, a light source, and a housing;
the housing defines a slit configured to receive light from the light source; and
the housing comprises a first reflective surface configured to redirect light from the light source to a polycarbonate substrate configured to refract the light into a camera sensor of the camera.

3. The method of claim 1, wherein the slit is formed by a first and second razor blade disposed on the housing.

4. The method of claim 1, wherein the polycarbonate substrate comprises an optical disc.

5. The method of claim 1, wherein processing the intensity profile based on the one or more image capture conditions comprises:
determining the one or more image capture conditions includes at least one of a set of lighting conditions, a background color, a container type in which the sample is disposed, or a source of the sample; and
modifying the intensity profile based on the one or more image capture conditions by applying a modifier defined by the one or more image capture conditions.

6. The method of claim 1, wherein applying the calibration factor comprises subtracting at least one reference spectra from the processed intensity profile.

7. The method of claim 6, wherein subtracting the at least one reference spectra comprises subtracting at least one of a reference spectra for at least one other nutrient or a reference spectra for a solvent in which the sample is dissolved.

8. A smartphone-based spectrophotometer comprising:
a housing comprising a front face, a rear face, a reflective surface support portion disposed between the front face and the rear face at an angle adjacent a base of the housing, and a diffraction grating support portion extending from an upper portion of the front face to a portion of the housing adjacent an upper portion of the rear face;
a reflective surface disposed on the reflective surface support portion in an interior of the housing;
a diffraction grating disposed on the diffraction grating support portion in the interior of the housing;
a cuvette holder configured to receive a cuvette having a sample therein and at least temporarily couple the cuvette adjacent the front face; and
a light source, wherein:
the front face defines a slit disposed adjacent the sample when the cuvette holder is coupled to the housing;
the housing is configured to support a smartphone having a camera adjacent the rear face of the housing, with the camera facing the housing;
the light source is configured to cause light to pass through the sample, through the slit, reflect off the mirror and into the diffraction grating; and
the diffraction grating is configured to direct incident light from the diffraction grating into the camera.

9. The smartphone-based spectrophotometer of claim 8, wherein the angle is forty five degrees.

10. The smartphone-based spectrophotometer of claim 8, wherein:
the housing comprises a first razor blade and a second razor blade disposed adjacent the slit and spaced apart from one another; and
the first razor blade and the second razor blade define the slit.

11. The smartphone-based spectrophotometer of claim 10, wherein a first sharpened edge of the first razor blade is parallel to and spaced apart a distance from a second sharpened edge of the second razor blade.

12. The smartphone-based spectrophotometer of claim 11, wherein the distance is up to about 3 millimeters.

13. The smartphone-based spectrophotometer of claim 8, wherein the diffraction grating comprises an optical disk.

14. A method of determining an amount of a nutrient in a sample, the method comprising:
providing a spectrophotometer;
capturing, using the spectrophotometer, an image of the sample;
generating, by computing hardware, a pixel intensity profile of the image;
mapping, by the computing hardware, a pixel position of each pixel to a wavelength;
calculating, by the computing hardware, an absorbance at least wavelength;
generating, by the computing hardware, an absorbance spectra based on the absorbance at each wavelength; and
providing, by the computing hardware, the absorbance spectra for display on a computing device.

15. The method of claim 14, wherein the spectrophotometer is a smartphone-based spectrophotometer comprising:
a housing comprising a front face, a rear face, a reflective surface support portion disposed between the front face and the rear face at an angle adjacent a base of the housing, and a diffraction grating support portion extending from an upper portion of the front face to a portion of the housing adjacent an upper portion of the rear face;
a reflective surface disposed on the reflective surface support portion in an interior of the housing;
a diffraction grating disposed on the diffraction grating support portion in the interior of the housing;
a cuvette holder configured to receive a cuvette having a sample therein and at least temporarily couple the cuvette adjacent the front face; and
a light source, wherein:
the front face defines a slit disposed adjacent the sample when the cuvette holder is coupled to the housing;
the housing is configured to support a smartphone having a camera adjacent the rear face of the housing, with the camera facing the housing;
the light source is configured to cause light to pass through the sample, through the slit, reflect off the mirror and into the diffraction grating; and
the diffraction grating is configured to direct incident light from the diffraction grating into the camera to capture the image.

16. The method of claim 15, further comprising determining, based on the absorbance spectra, an amount of the nutrient in the sample.

17. The method of claim 14, further comprising modifying the absorbance spectra based on one or mor reference spectra.

18. The method of claim 17, wherein modifying the absorbance spectra comprises subtracting at least one of the one or more reference spectra from the absorbance spectra.

19. The method of claim 18, wherein subtracting the at least one of the one or more reference spectra comprises subtracting at least one of a reference spectra for at least one other nutrient or a reference spectra for a solvent in which the sample is dissolved.
